(19) United States
(12) Patent Application Publication
(10) Pub. No.: US 2015/0288221 A1
(43) Pub. Date: Oct. 8, 2015

(54) Energy Efficient Electrical Appliance without Phantom Power Consumption

(71) Applicant: Yang Pan, Singapore (SG)

(72) Inventor: Yang Pan, Singapore (SG)

(21) Appl. No.: 14/247,253

(22) Filed: Apr. 8, 2014

(51) Int. Cl. H02J 9/06; H02J 17/00

(52) U.S. Cl. CPC H02J 9/06; H02J 17/00

(57) ABSTRACT

An energy efficient appliance is switched off completely from a main power supply when it is not in operation to deliver designed functionalities. An auxiliary power supply is employed to provide power for receiving restarting signal from a remote control device. In one embodiment, the auxiliary power supply receives power wirelessly from the remote control device to switch on the main power supply. In another embodiment, the auxiliary power supply receives power by harvesting energy available in environment. In still another embodiment, the auxiliary power supply is a replaceable or rechargeable battery. The appliance includes televisions, digital video recorders, air conditioners, lighting systems, audio systems and microwave ovens. The appliance may also include a door open system for a home or for an automobile.

### CROSS-REFERENCE TO RELATED APPLICATIONS

Not applicable.

### BACKGROUND—FIELD OF INVENTION

This invention relates to an electrical appliance, specifically to an energy efficient electrical appliance without consuming phantom power.

### BACKGROUND-DESCRIPTION OF PRIOR ART

For various reasons, energy consumption is being increasingly scrutinized by residential and business consumers. Much effort has been made in recent years to provide electrical appliances of all types that consume reduced amount of electrical power. Such appliances have been well received in the market place and are highly desirable. While great strides have been made in providing energy efficient electrical appliances, more improvements are desired in particularly in areas of eliminating phantom power.

The so called phantom power or energy vampire is caused by standby power of electrical appliances such as, for example, televisions, digital video recorders, air conditioners, home audio systems and microwave ovens. The electrical appliances require the standby power to receive control signals from remote control devices to restart operations of the appliance from standby mode. Many billions of dollars have been wasted because of the phantom power that provides little or no desired functionalities of the electrical appliances. Therefore, it is desirable to provide energy efficient electrical appliances without consuming phantom power.

### SUMMARY OF THE INVENTION

It is an object of the present invention for providing an energy efficient electrical appliance that does not consume phantom power.

It is another object of the present invention for providing an energy efficient electrical appliance that receives power from a remote control device to restart the appliance that was switched off completely from a power grid.

It is yet another object of the present invention for providing an energy efficient electrical appliance that receives power from an energy harvest device to restart the appliance that was switched off completely from a power grid, wherein the energy harvest device receives and stores power from environment.

It is still another object of the present invention for providing an energy efficient electrical appliance that receives power from an energy storage device to restart the appliance that was switched off completely from a power grid, wherein the energy storage device further includes a replaceable or rechargeable battery.

The electrical appliances include but are not limited to a television system, a digital video recorder, an audio system, an air conditioner, a lighting system and a microwave oven. The inventive concept can also be extended to a door opening system using a remote control device including but is not limited to a door opening system for a home, an office and a vehicle such as, for example, an automobile.

### BRIEF DESCRIPTION OF THE DRAWINGS

For a more complete understanding of the present invention and its various embodiments, and the advantages thereof, reference is now made to the following description taken in conjunction with the accompanying drawings:

FIGS. 1A-D is a schematic diagram of an exemplary energy efficient electrical appliance including a main power supply and an auxiliary power supply;

FIG. 2 is a table illustrating various energy sources for the auxiliary power supply;

FIG. 3 is a flow diagram depicting operation of the electrical appliances in accordance with the first embodiment;

FIG. 4 is a flow diagram depicting operation of the electrical appliances in accordance with the second embodiment;

FIG. 5 is a flow diagram depicting operation of the electrical appliances in accordance with the third embodiment.

### DETAILED DESCRIPTION

The present invention will now be described in detail with references to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps have not been described in detail in order not to unnecessarily obscure the present invention.

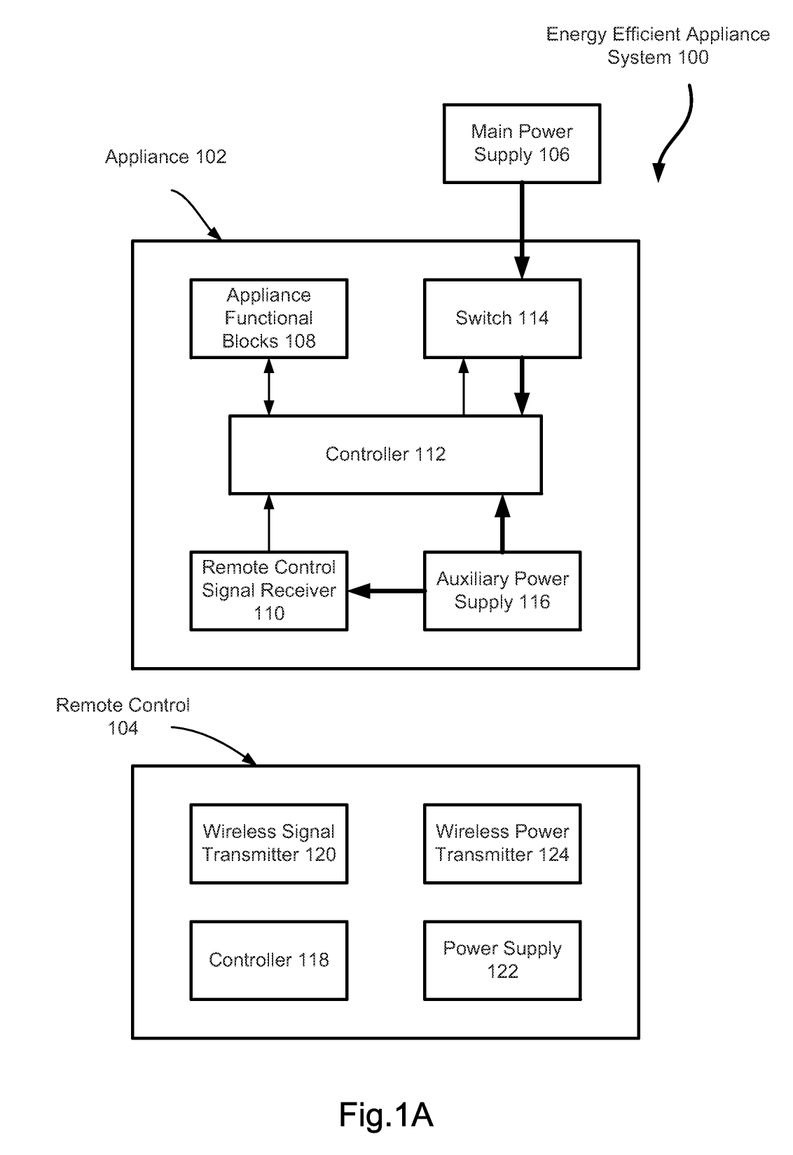

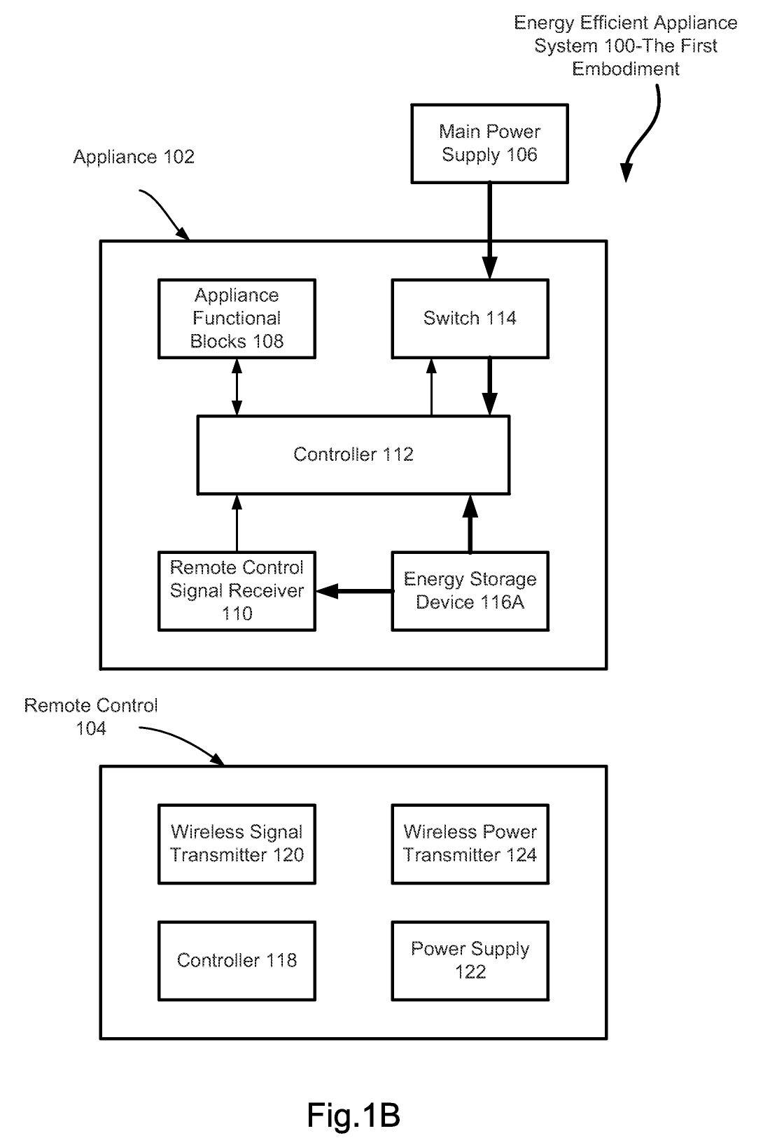

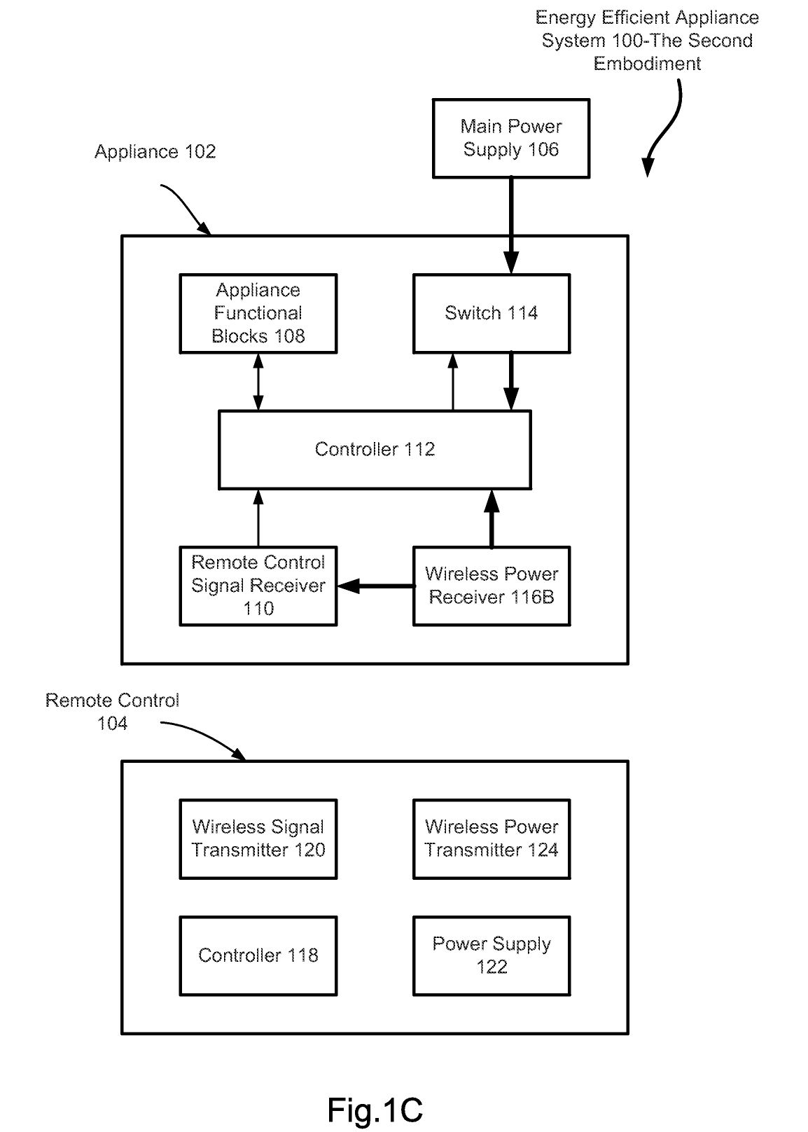

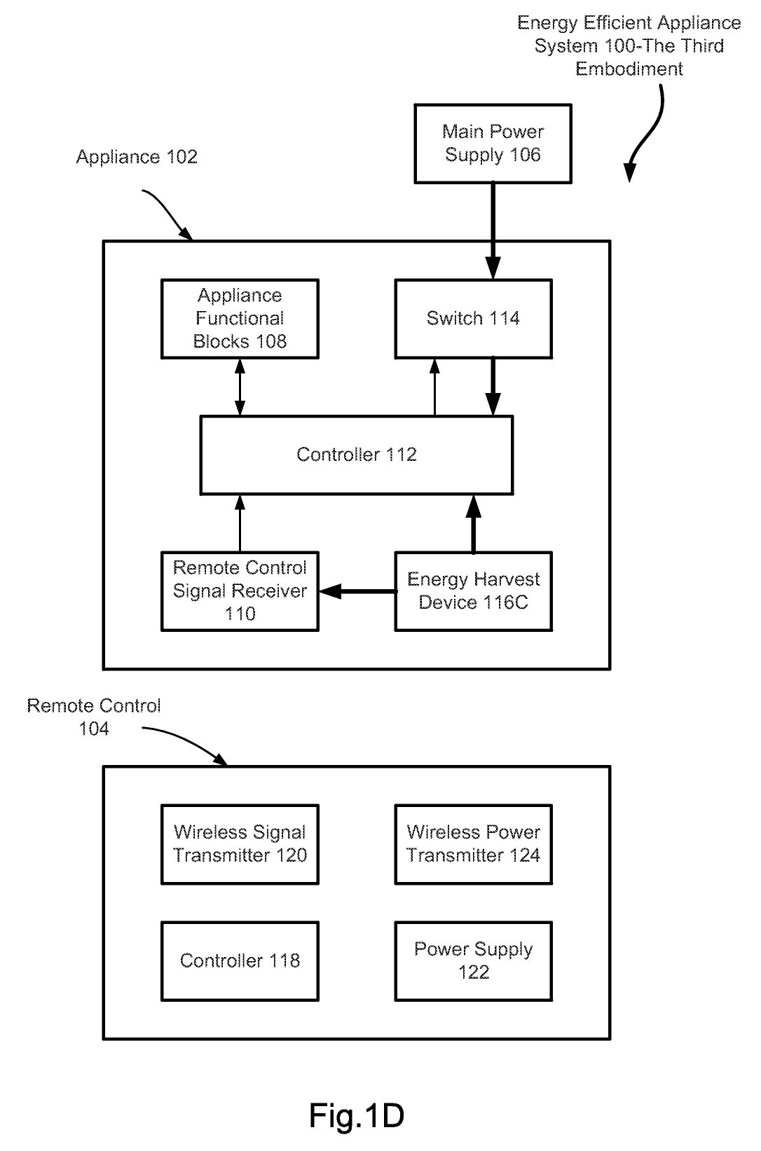

FIG. 1A is a schematic diagram of an exemplary energy efficient electrical appliance system 100. Thin arrows indicate at least a part of signal flow and thick arrows indicate at least a part of energy flows. Appliance system 100 comprises an appliance 102, a remote control device 104 and a main power supply 106. Appliance 102 includes but is not limited to a television system, a digital video recorder, an audio system, an air conditioner, a lighting system and a microwave oven. The television system may include a set top box. The inventive concept can also be extended to a door opening system using a remote control device including but is not limited to a door opening system for a home, an office and a vehicle such as, for example, an automobile. The inventive concept can be applied to any type of systems including an appliance, an apparatus and a device, wherein a remote control device is used to switch on the system from a standby status. Appliance 102 performs a set of designed functionalities when it is connected to main power supply 106. In present disclosure, appliance 102 is operated in a “switched off” mode when it is completely disconnected from main power supply 106. There is no electrical power flows from main power supply 106 to appliance 106 in the “switched off” mode. Appliance 102 is in a “standby” mode when appliance 102 is no long delivering designed functionalities but is still receiving power from main power supply 106 to maintain a wireless communication link between appliance 102 and remote control device 104 active.

In an exemplary case, main power supply 106 is connected to a power grid (not shown in FIG. 1A). In another exemplary case, main power supply 106 is connected to an alternative energy source such as, for example, a solar power panel or a wind turbine. Main power supply 106 may be either an AC power supply or a DC power supply.

Appliance 102 further includes appliance functional blocks 108 pertaining to perform designed functionalities of the appliance. A remote control signal receiver 110 is pertaining to receiving remote control signals from remote control device 104. As well known in the art, infrared (IR) signals are used to transmit control signals from remote control device 104 to appliance 102. Other wireless communication protocols including but are not limited to Bluetooth and ZigBee can also be used for the communication link. In a conventional implementation, remote control signal receiver 110 continues to be powered by main power supply 106 after functional blocks 108 is switched off from the main power supply.

Operations of appliance 102 are controlled by controller 112. In an exemplary case, controller 112 is a microcontroller or a microprocessor. Controller 112 may also include a special purpose processor such as, for example, a Digital Signal Processor (DSP) or a Graphical Processing Unit (GPU).

In present invention, appliance 102 further includes a switch 114. Switch 114 is an electrical signal controlled switch. In one implementation, switch 114 is a relay. In another implementation, switch 114 is a transistor. When switch 114 is switched on by an electrical signal, electrical power flows from main power supply 106 to appliance 102. When switch 114 is switched off by another electrical signal, electrical power is ceased to flow into appliance 102.

Appliance 102 further includes an auxiliary power supply 116. In accordance with the first embodiment as shown in FIG. 1B, auxiliary power supply 116 is an energy storage device 116A. In one implementation, energy storage device 116A is a replaceable battery. Appliance 102 includes an open slot for receiving at least one piece of battery. In another implementation, energy storage device 116A is a rechargeable battery, wherein the battery can be charged when appliance 102 is connected to main power supply 106. In yet another implementation, energy storage device 116A is a capacitor that stores charges when appliance 102 is connected to main power supply 106.

In the “switched off” mode, remote control signal receiver 110 receives power from auxiliary power supply 116. Upon receiving a restarting signal, triggered by remote control controller 118, transmitted from a wireless signal transmitter 120 in the remote control device, the signal receiver 110 sends a control signal to the appliance controller 112. Controller 112 powered by auxiliary power supply 116 generates an electrical signal to switch on switch 114. Appliance 102 is subsequently connected to main power supply 106. After main power supply 106 is connected to appliance 102, auxiliary power supply 116 is ceased to provide power to appliance 102. When the energy storage device 116A is used according to the first embodiment, controller 112 may decide to charge the energy storage unit. Remote control 104 is powered by a power supply 122. Power supply 122 is a battery in an exemplary case.

In accordance with the second embodiment as shown in FIG. 1C, auxiliary power supply 116 includes a wireless power receiver 116B. Power in a wireless form, as transmitted from wireless power transmitter 124 located in remote control device 104, is received by the wireless power receiver 116B. A power processing unit as a part of the wireless power receiver 116B is used to convert received power into an appropriate form such as, for example, into a DC voltage with a predetermined value to power restarting operations of appliance 102. Appliance 102 is then fully functioning after electrical power flows from main power supply 106 into appliance 102.

In one implementation, the wirelessly transmitted power may be in a form of radio frequency electromagnetic wave. The transmitted power may be un-coded and carry no data. The wireless power receiver 116B includes a radio frequency power receiver in such an implementation. In another implementation, the wirelessly transmitted power may be in a form of visible or invisible light. The wireless power receiver 116B then includes an optical power receiver.

In accordance with the third embodiment as shown in FIG. 1D, auxiliary power supply 116 is an energy harvest device 116C. The energy harvest device 116C receives energy from environment and stores received energy in a storage unit. The stored energy is processed to an appropriate form such as, for example, to a DC voltage with a predetermined value. Remote control signal receiver 110 is then powered by the energy harvest device 116C to receive a restarting signal from the remote control device 104. Energy stored in the energy harvest device can subsequently be used to switch on the switch 114. Subsequently, electrical power from main power supply 106 flows into the appliance 102 to support the appliance to deliver designed functionalities.

In one implementation, the energy harvest device 116C receives and stores radio frequency power. In another implementation, the energy harvest device 116C receives and stores optical energy. In yet another implementation, the energy harvest device 116C includes a solar cell or a solar panel for receiving optical energy from the environment. The solar cell or the solar panel may be installed on surfaces of the appliance 102.

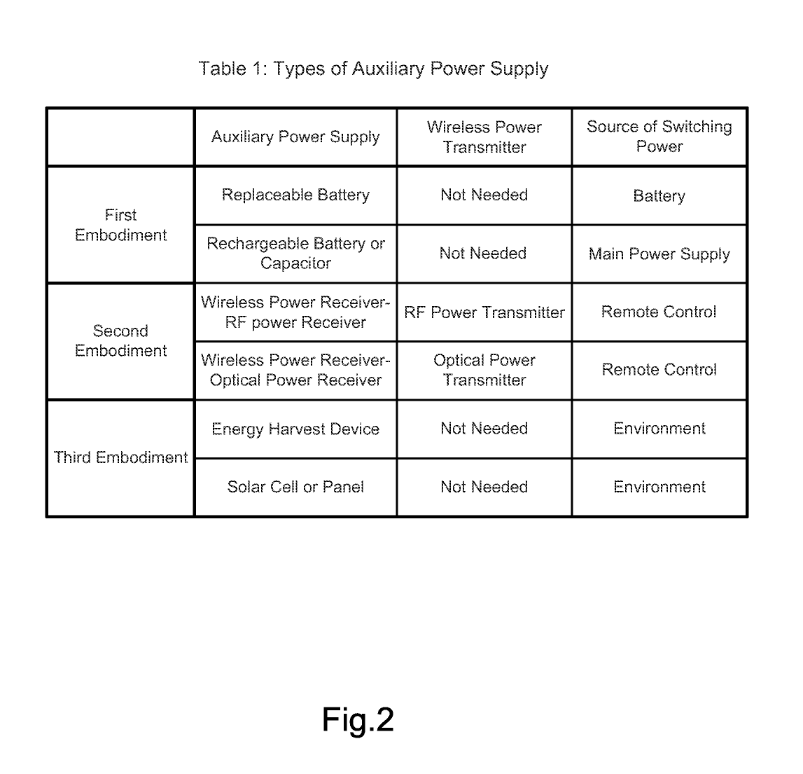

FIG. 2 illustrates a table that summarizes various implementations of auxiliary power supply 116 in accordance with the three embodiments. Sources of the power for switching on main power supply are also listed.

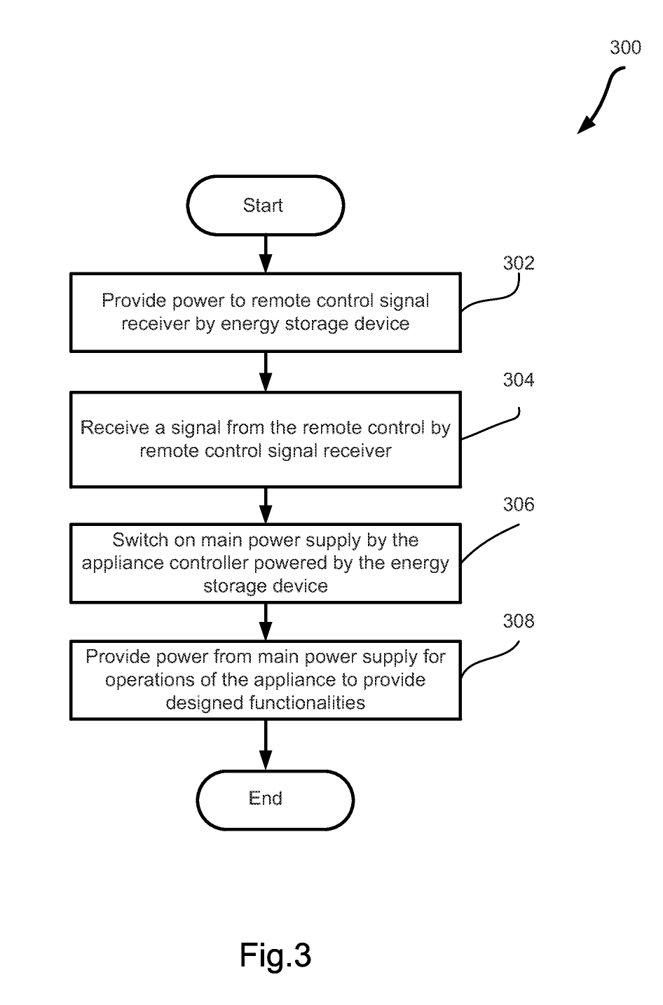

FIG. 3 is a flow diagram depicting operations of electrical appliance system 100 in accordance with the first embodiment. Process 300 starts with step 302 that the signal receiver 110 is powered by the energy storage device 116A. In step 304, the signal receiver 110 receives a signal from the remote control 104, through the wireless communication link between the remote control 104 and the appliance 102, to restart the operation of appliance 102. Upon receiving the signal, the signal receiver 110 sends a control signal to the appliance controller 112, powered also by the energy storage device 116A. In such a circumstance, the appliance controller 112 provides only limited functions in order to save power consumption of the energy storage device 116A. The appliance controller 112 sends an electrical signal to switch on switch 114 in step 306. Electrical power is subsequently flows from main power supply 106 to appliance 102 for powering of operations of appliance 102 to deliver designed functionalities in step 308.

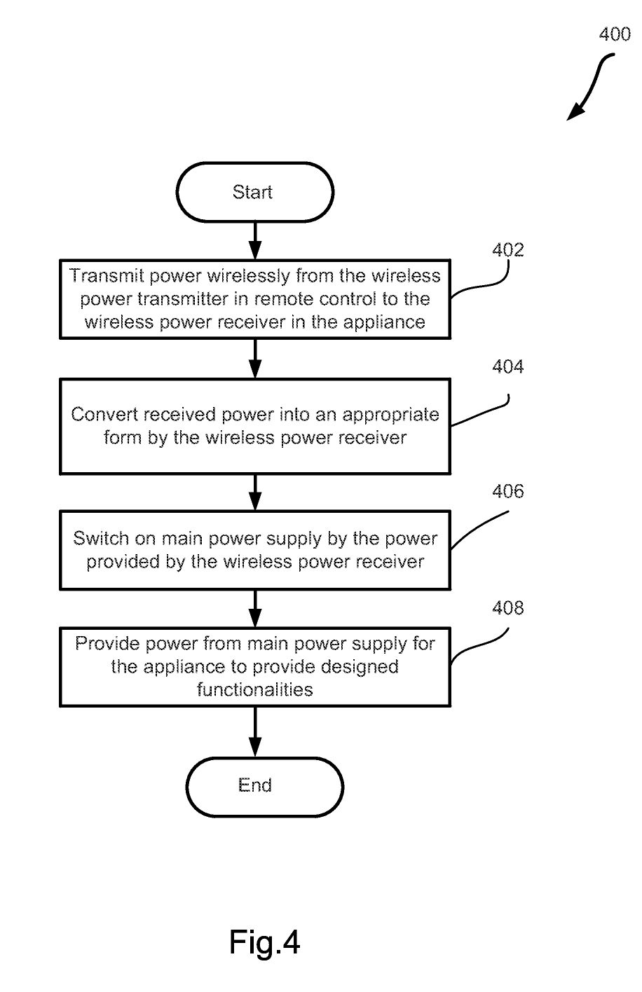

FIG. 4 is a flow diagram depicting operation of electrical appliance system 100 in accordance with the second embodiment. Process 400 starts with step 402 that power is transmitted wirelessly from wireless power transmitter 124 in remote control device 104 to the wireless power receiver 116B in appliance 102. In step 404, received power is converted into an appropriate form such as, for example, into a DC voltage with a predetermined value. The received power is employed in step 406 by the appliance controller 112 to switch on switch 114. In step 408, electrical power from main power supply 106 flows into appliance 102 for powering operations of appliance 102 to deliver designed functionalities.

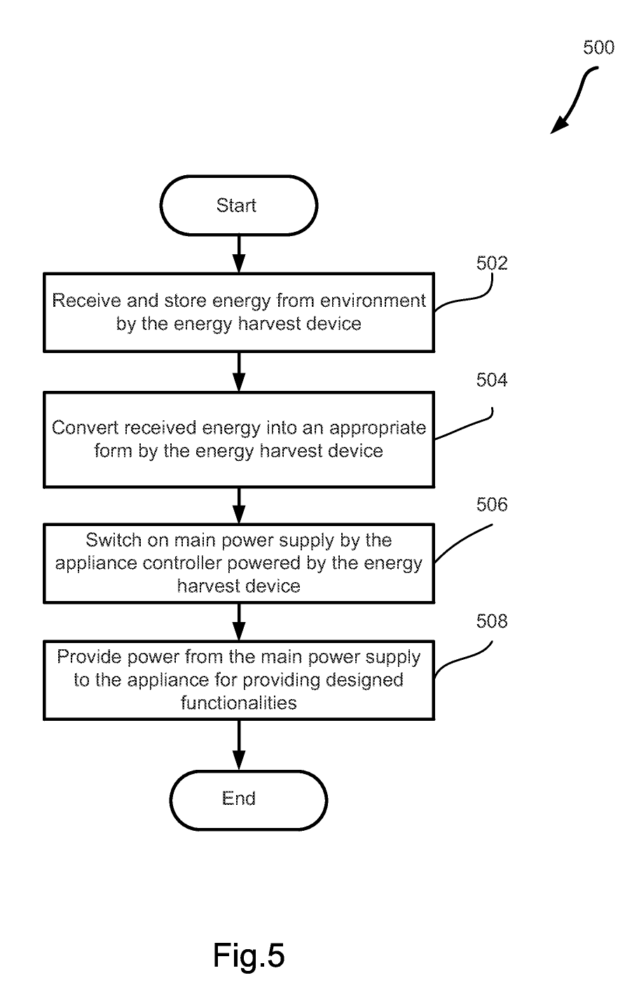

FIG. 5 is a flow diagram depicting operation of electrical appliance system 100 in accordance with the third embodiment. Process 500 starts with step 502 that energy from environment is received and stored in the energy harvest device 116C. In step 504, stored power is converted into an appropriate form such as, for example into a DC voltage with a predetermined value. Power supplied by the energy harvest device 116C is used to provide power for the signal receiver 110. In step 506, the power is used to switch on switch 114 after receiving a restarting signal from remote control 102 by the signal receiver 110. In step 508, electrical power from main power supply 106 flows into appliance 102 for powering its operation to deliver designed functionalities.

1. An electrical appliance system comprising:
(a) a main power supply connected to functional blocks of the appliance through an electrical signal controlled switch, wherein no power flows from the main power supply to the functional blocks when said switch is switched off;
(b) a remote control device; and
(c) an auxiliary power supply pertaining to supplying power for switching on said switch, wherein said auxiliary power supply further including a wireless power receiver for receiving power transmitted wirelessly from a wireless power transmitter of the remote control device.

2. The system as recited in claim 1, wherein said power is transmitted from said wireless power transmitter to wireless power receiver in a form of a radio frequency electromagnetic wave.

3. The system as recited in claim 2, wherein said transmitted power is in a form of an un-coded radio frequency electromagnetic wave.

4. The system as recited in claim 1, wherein said wireless power receiver further including a power processing unit pertaining to processing received power into an appropriate form for operation of the appliance.

5. The system as recited in claim 1, wherein said switch is a relay.

6. The system as recited in claim 1, wherein said main power supply is connected to a power grid.

7. The system as recited in claim 1, wherein said system further including a television system.

8. The system as recited in claim 1, wherein said system further including a digital video recorder.

9. The system as recited in claim 1, wherein said system further including an air conditioner.

10. The system as recited in claim 1, wherein said system further including a door open system for a home or an automobile.

11. An electrical appliance system comprising:
(a) a main power supply connected to functional blocks of the appliance through an electrical signal controlled switch, wherein no power flows from the main power supply to the functional blocks when said switch is switched off;
(b) a remote control device; and
(c) an auxiliary power supply pertaining to supplying power for switching on said switch,
wherein said auxiliary power supply further including an energy harvest device for receiving and storing energy collected from environment.

12. The system as recited in claim 11, wherein said energy collected from environment further including optical energy.

13. The system as recited in claim 11, wherein said energy collected from environment further including radio frequency electromagnetic wave energy.

14. The system as recited in claim 11, wherein said energy harvest device further including a processing unit pertaining to processing received and stored energy into an appropriate form for operation of the appliance.

15. The system as recited in claim 11, wherein said energy harvest device further including a solar cell or a solar panel.

16. An electrical appliance system comprising:
(a) a main power supply connected to functional blocks of the appliance through an electrical signal controlled switch, wherein no power flows from the main power supply to the functional blocks when said switch is switched off;
(b) a remote control device; and
(c) an auxiliary power supply pertaining to supplying power for switching on said switch, wherein said auxiliary power supply further including an energy storage device.

17. The system as recited in claim 16, wherein said energy storage device is a replaceable battery.

18. The system as recited in claim 16, wherein said energy storage device further including a rechargeable battery, where said battery can be recharged when said switch is switched on.

19. The system as recited in claim 16, wherein said energy storage device further including a capacitor for storing charges when said switch is switched on.

20. The system as recited in claim 16, wherein said system further including a television system.
